(19) United States
(12) Patent Application Publication
(10) Pub. No.: US 2025/0144687 A1
(43) Pub. Date: May 8, 2025

(54) MACHINE AND METHOD FOR CARRYING OUT SURFACE TREATMENTS ONTO ROLLING MILL ROLLS

(71) Applicant: TENOVA S.P.A., Milano (IT)

(72) Inventors: Paolo GABOARDI, Milano (IT); Claudio TREVISAN, Milano (IT); Andrea GARIANO, Milano (IT); Giovanni BOSELLI, Milano (IT)

(73) Assignee: TENOVA S.P.A., Milano (IT)

(21) Appl. No.: 18/730,168

(22) PCT Filed: Jan. 24, 2023
(86) PCT No.: PCT/IB2023/050588

§ 371 Date: Jul. 18, 2024

(30) Foreign Application Priority Data
Jan. 25, 2022 (IT) 102022000001202

(51) Int. Cl. B21B 28/02; B23K 26/00; B23K 26/08; B23K 26/352

(52) U.S. Cl. CPC B21B 28/02; B23K 26/0093; B23K 26/0823; B23K 26/355

(57) ABSTRACT

A machine for carrying out surface treatments onto rolling mill rolls, which includes a supporting structure extending along a longitudinal direction of development, a casing placed at least partially to cover the supporting structure, at least two supporting elements placed on the supporting structure opposed to each other and aligned along a rotation axis parallel to the longitudinal direction of development, a rotation motor configured to put in rotation the roll when supported by the two supporting elements, a grinding group slidably connected to the supporting structure and which includes a grinding tool, a texturing group slidably connected to the supporting structure and which includes a laser head, and a control unit placed in signal communication with the grinding group and with the texturing group and configured to control the grinding group and the texturing group.

The present invention relates to a machine for carrying out surface treatments onto cylindrical bodies, in particular rolling mill rolls intended for rolling mills, hot or cold, for producing flat rolled metal products, for example metal sheet tapes of steel, aluminium or other metal materials.

The present invention also relates to a method for carrying out surface treatments onto a roll by said machine.

The present invention is usefully used to suitably restore the operating conditions of rolls after using them.

Using rolls to obtain rolled metal products from thicker metal semi-finished products is known in the state of the art. In particular, the thickness of such semi-finished products is reduced through forced passage between two or more rolls, placed at a set distance therebetween.

It is also known that the rolls are subjected to a progressive deterioration, after a given number of working hours in a rolling mill or after a given amount of rolled material, due to the contact with the pieces subjected to rolling. Such deterioration occurs in various manners, depending on the typology of the performed treatment and the treated material, for example with:
impurities accumulated on the surface of the roll, due to lubricants, traces of flakes and other metal residues and abrasive fragments;
wear of the surface, that is loss of the features of surface roughness, useful to give the needed roughness to the metal semi-finished product being treated; for example, the roughness, expressed as Ra (Arithmetic Average Roughness) and Rpc (numerousness of peaks), is subjected to an alteration in the value of some parameters, higher than a prefixed limit, for example 20% of the nominal value;
wear of the profile, as in some cases the correct profile needed to compensate the bending of the roll during rolling is lost;
cracks and other localized damages of various type, shape, and depth;
work hardening of the surface layer;
fatigue layer, due to the high stresses, beyond the yield point of the material, the surface layer is subjected to, creating oligocyclic fatigue phenomena;
other damages, such as stains or rolling signs.

Following such deterioration, in order to re-establish the suitable dimensional, geometrical, and structural operating conditions (e.g., the geometrical profile, the surface features, etc.) of a roll, this is subjected to specific surface treatments for material removal. Thus, it is necessary to temporarily remove the roll from the rolling mill stand, replacing it with a similar roll, for carrying out such treatments.

A first type of treatment provides for reconditioning the surface of the roll by removing a certain material thickness from the roll. This process, generally conducted through a grinding wheel, is known as grinding and allows to restore the profile, that is the shape, the roundness and the eccentricity in the tolerances required by the rolling mill, eliminate as much as possible the surface defects, such as cracks or dents, and restore the correct roughness in terms of Ra and/or Rpc.

A second type of treatment, optional but however conducted subsequently to the grinding, is known as texturing and is aimed at giving determined roughness features to the surface of the roll. Indeed, the roughness of the roll affects in turn the roughness of the rolled product, improving features thereof such as the formability, the paintability, etc. The texturing treatment is performed on certain specific typologies of rolls, for example on rolls intended for cold rolling operations, and in particular on rolls intended for the last stage of rolling, so-called “skin pass”.

The texturing is carried out for example through sandblasting (shot blasting), electrostatic discharges (electrical discharge texturing, EDT), by an electron beam (electron beam texturing, EBT) or by a laser beam (laser beam texturing, LBT, and/or laser texturing, LT). Among these, the texturing by laser beam is the one which allows to obtain the widest variety of typologies of surface features on the roll, as it allows to accurately control a high number of parameters affecting the process, for example average and peak power of the laser, size and shape of the beam, focusing conditions of the beam and so on.

To this day, the grinding and texturing treatments onto the rolls are carried out with dedicated machines, distinct and separated from each other and with features different from each other, each designated for a specific treatment.

For example, documents WO 2021005489 A1 and EP 2794178 B1 disclose texturing machines for rolls comprised of laser heads.

Instead, document EP 2808099 B1 discloses a method for making rolls with a particular surface structure.

Disadvantageously, moving the rolls between the grinding machine and the texturing machine is difficult due to the size and the weight the rolls have. The need to displace the roll between a machine and another further lengthens the treating time of the roll itself.

Disadvantageously, the presence of two separated machines is also reflected in a larger occupation of space and of depreciation and plant costs, for example due to the connections.

An object of the present invention is to solve the above-mentioned drawbacks and in particular to design a machine and a method for carrying out surface treatments onto rolls which allow a reduced handling of the rolls themselves.

Another object of the present invention is to provide a machine and a method for carrying out surface treatments onto rolls which make the time required to refresh the surface features of a roll quicker.

A further object of the present invention is to make a machine and a method for carrying out surface treatments onto rolls which allow to save space.

These and other objects according to the present invention are achieved by making a machine and a method for carrying out surface treatments onto rolls as set forth in independent claims 1 and 20.

Further features of the machine for carrying out surface treatments onto rolls are the subject of the dependent claims.

The features and advantages of the machine and the method for carrying out surface treatments onto rolls according to the present invention will be more evident from the following, exemplary and therefore not limiting, description, referred to the attached schematic drawings, in which:

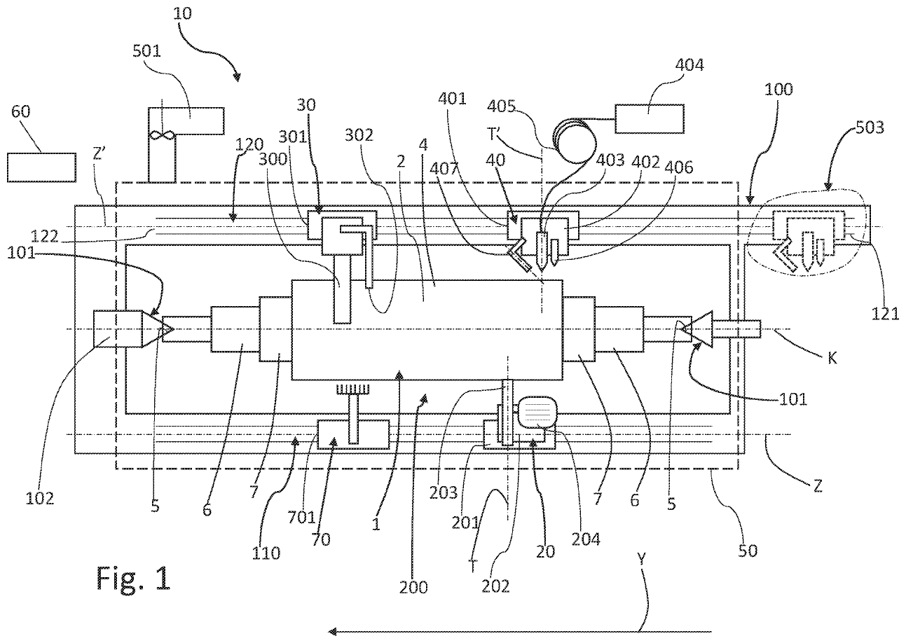

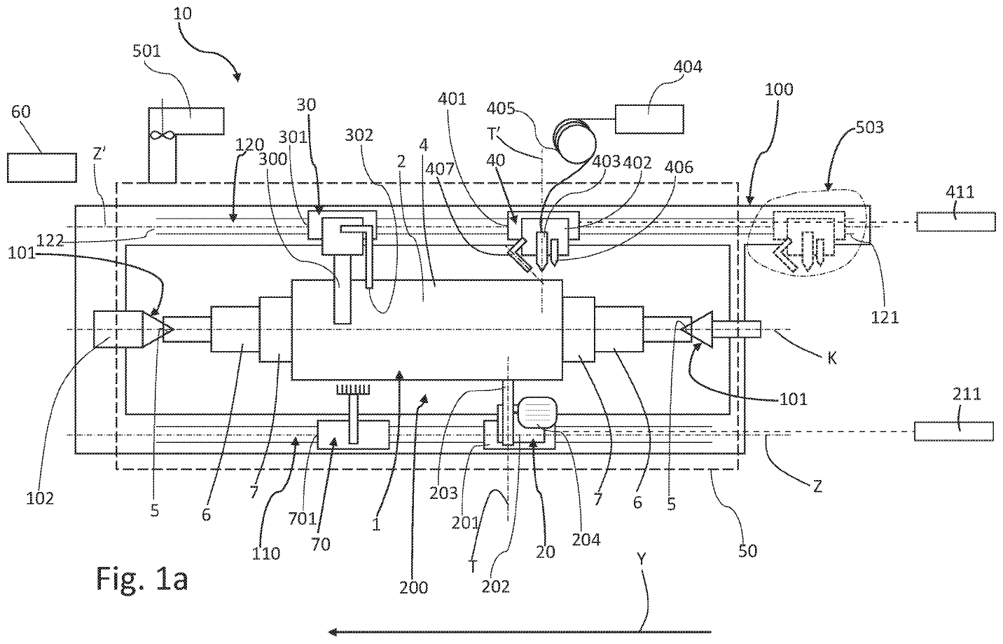

FIGS. 1 and 1a show a top view of an embodiment of a machine for carrying out surface treatments onto rolls according to the present invention;

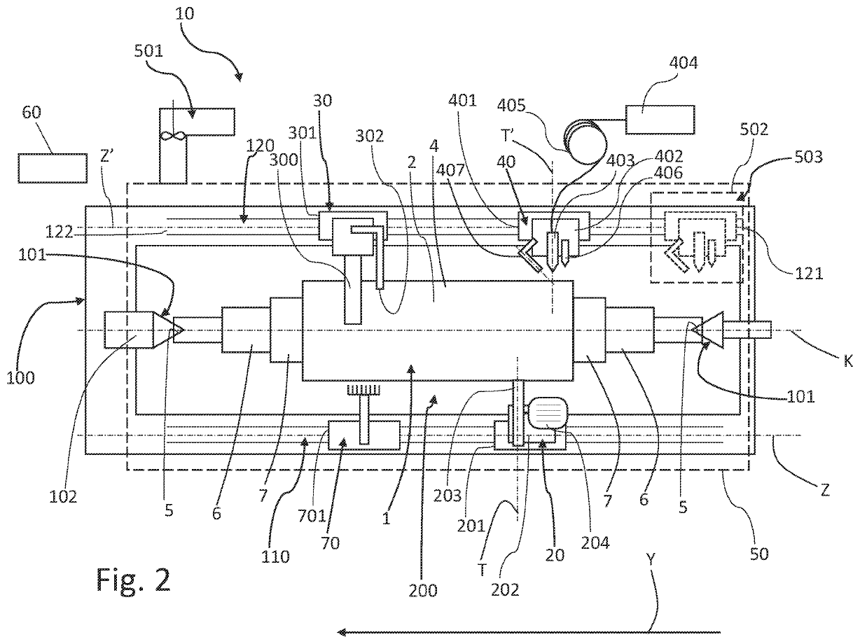

FIG. 2 shows a top view of a second embodiment of a machine for carrying out surface treatments onto rolls according to the present invention;

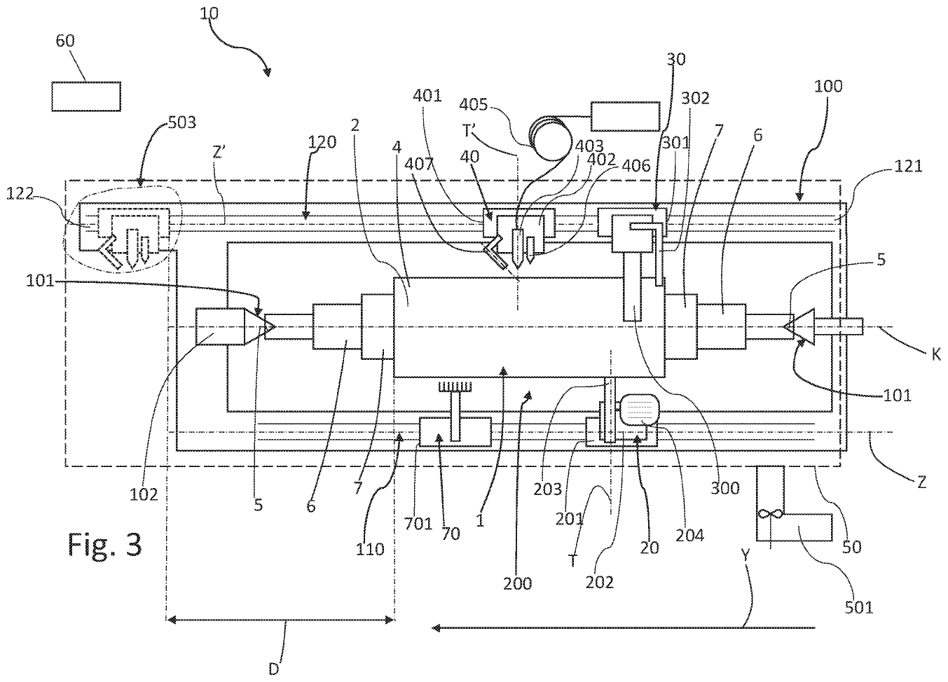

FIG. 3 shows a top view of a third embodiment of a machine for carrying out surface treatments onto rolls according to the present invention;

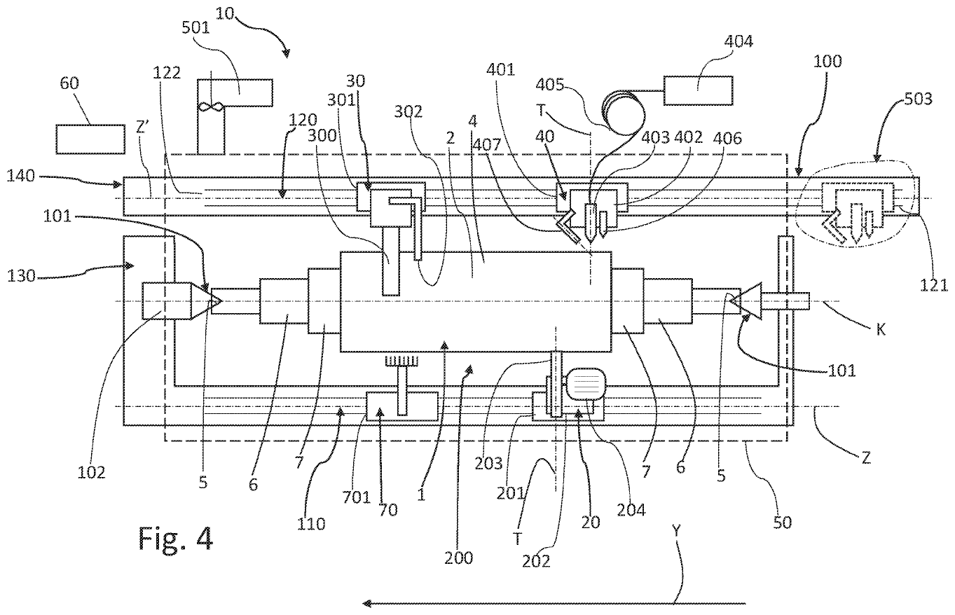

FIG. 4 shows a top view of a fourth embodiment of a machine for carrying out surface treatments onto rolls according to the present invention;

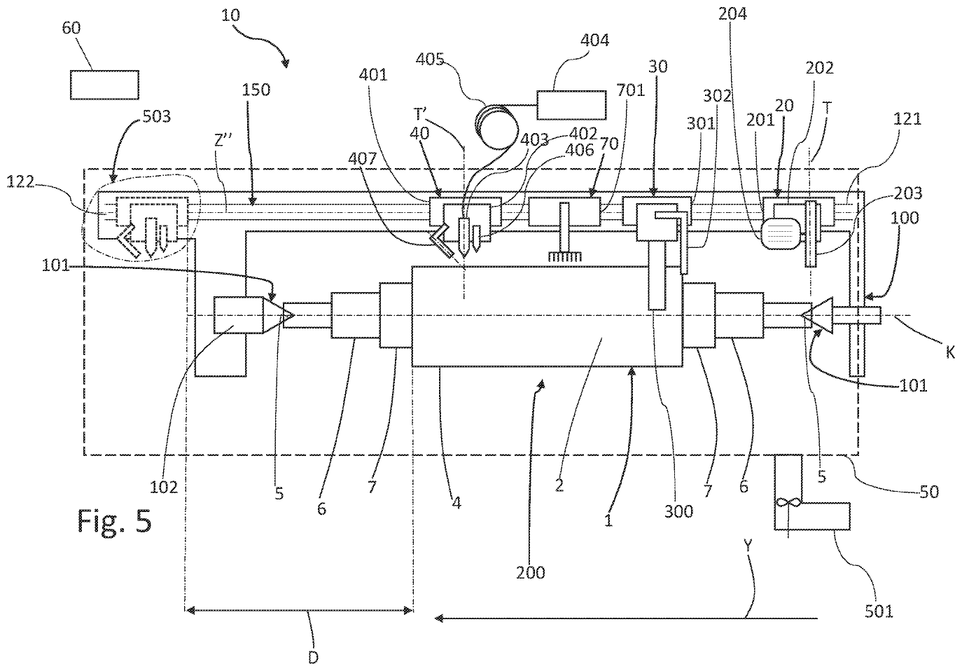

FIG. 5 shows a top view of a fifth embodiment of a machine for carrying out surface treatments onto rolls according to the present invention;

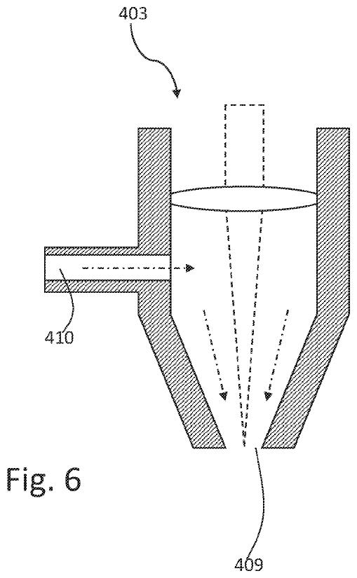

FIG. 6 shows a sectional view of a detail of an embodiment of a machine for carrying out surface treatments onto rolls according to the present invention;

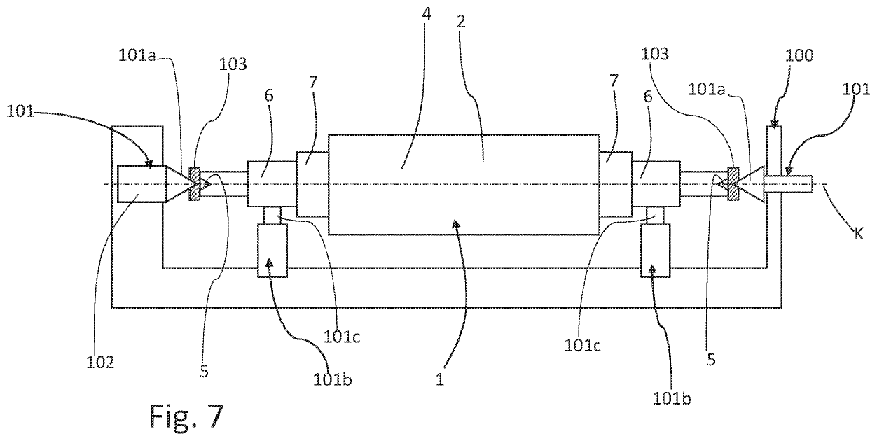

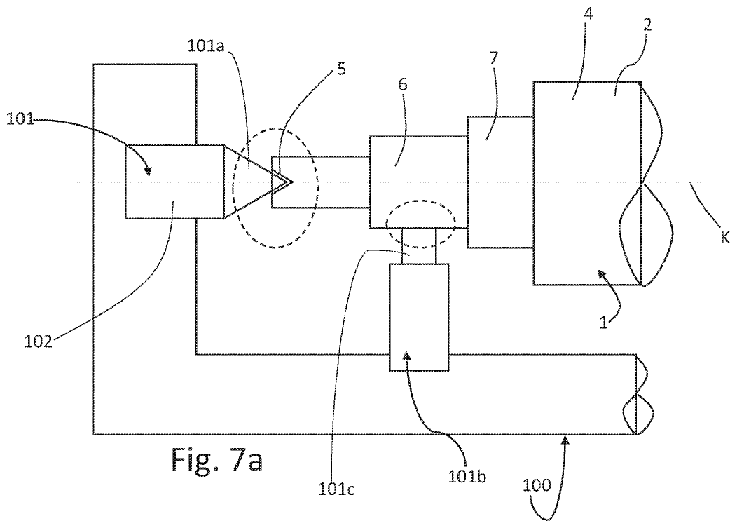

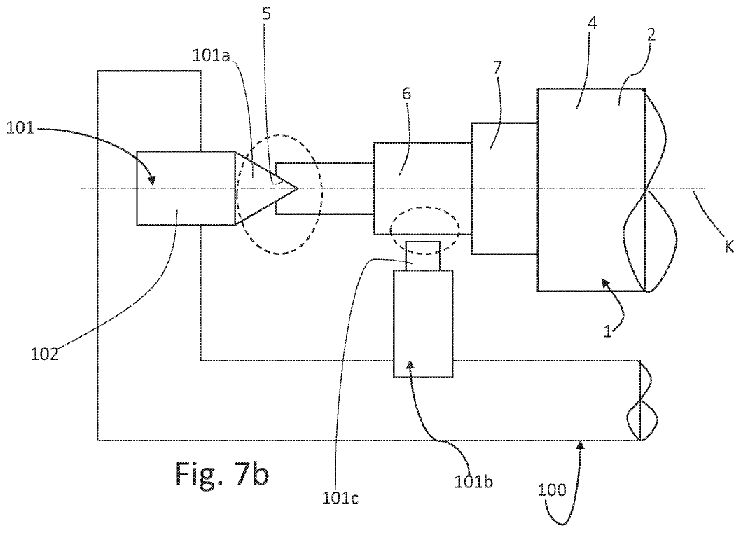

FIGS. 7, 7a and 7b show side views of other details of a machine for carrying out surface treatments onto rolls according to the present invention.

With reference to the attached figures, a machine for carrying out surface treatments onto rolls 1, marked with reference number 10, is described.

The machine 10 comprises a supporting structure 100 extending along a longitudinal direction (Y) of development.

Preferably, the machine 10 comprises a casing 50 placed at least partially to cover the supporting structure 100. More details about the casing 50 are provided later in the present disclosure.

The machine 10 comprises at least two supporting elements 101 placed on the supporting structure 100. The supporting elements 101 are opposed to each other and aligned along a rotation axis K which is parallel to the longitudinal direction Y of development and which represents the axis around which the roll 1 can rotate while the treatments are carried out.

In particular, the supporting elements 101 are configured to support a roll 1 which has a surface 2 to be treated.

The above-mentioned casing 50 is at least partially openable, in order to allow the positioning and removal of the roll 1 between the supporting elements 101. In more detail, the rolls 1 are always provided at their flat end surfaces two cone-shaped machinings, called centres 5, used for supporting the roll during the manufacturing thereof; furthermore a roll 1 has two respective first middle portions known as necks 6, at which plain bearings are mounted for inserting the roll 1 in the rolling mill, and two respective second middle portions known as shoulders 7 adjacent to the first middle portions. Adjacently to the shoulders 7, the roll 1 comprises a central portion known as table 4. It should be noted that the surface 2 to be treated of the roll 1 is part of the surface of the table 4, or the entire surface of the table 4.

Accordingly, it should be noted that the supporting elements 101 may be conformed to support the roll 1 being treated at the centres 5. Alternatively, the supporting elements 101 are conformed to support the roll 1 at the necks 6.

In a further alternative embodiment, the roll 1 is supported at the shoulders 7, for example if the roll 1 to be treated is positioned in the machine 10 without removing the roll chocks. By the way, the term “roll chocks” defines that prism-shaped structure made of steel or cast iron which serves as an interface between the roll 1 and the rolling mill.

The machine 10 may comprise even two or more supporting elements 101, in accordance with the above-mentioned different techniques for supporting the roll 1, in particular it may comprise supporting elements 101 adapted to hold the roll 1 at the centres 5 and further supporting elements 101 adapted to support the roll 1 at the necks 6 or the shoulders 7. Advantageously, the operating flexibility of the machine 10 is incremented. More details about the supporting elements 101 will be provided later in the present disclosure.

The machine 10 also comprises a rotation motor 102 configured to put in rotation the roll 1 when supported by the two supporting elements 101. In particular, the rotation motor 102 puts in rotation the roll 1 around the rotation axis K. Thereby, the roll 1 can rotate around the rotation axis K, being constrained to the supporting elements 101, to carry out the treatment. Preferably, the rotation motor 102 is integrated in one of the two supporting elements 101.

The machine 10 comprises a grinding group 20 which is slidably connected to the supporting structure 100. In particular, the grinding group 20 is configured to slide along a first direction Z parallel to the longitudinal direction Y of development. The grinding group comprises a grinding tool 203 which is able to face the roll 1 when inserted between the supporting elements 101. In particular, the grinding tool 203 is movable over a working zone 200 for grinding at least part of the surface 2 of the roll 1.

The grinding tool 203 is realized for example by a grinding wheel.

The grinding group 20 further comprises a grinding motor 204 configured to drive the grinding tool 203.

More details about the grinding group 20 will be provided later in the present disclosure.

In accordance with the present invention, the machine 10 also comprises a texturing group 40 slidably connected to the supporting structure 100. In particular, the texturing group 40 is configured to slide along a second direction Z′ parallel to the longitudinal direction Y of development.

In more detail, the texturing group 40 comprises a laser head 403 which is able to face the roll 1 when inserted between the supporting elements 101. In particular, the laser head 403 is movable over the working zone 200 for texturing at least part of the surface 2 of the roll 1. The laser head 403 is configured to emit a laser beam (not illustrated), directed towards the surface 2 of the roll 1. In accordance, the laser head 403 is connected to a laser source 404.

The above-mentioned casing 50 is made of a material which is opaque to the laser radiation.

Advantageously, the casing 50 represents a safety barrier with respect to the laser beam when the texturing group 40 is operating.

Furthermore, the casing 50 allows to contain the residues of the treatments carried out onto the roll 1. In particular, the casing 50 allows to enclose metal powder generated by the laser, due to the localized sublimation of the material of the roll 1.

Advantageously, the casing 50 also allows to avoid the vapor generated during the grinding process to be scattered and this allows the collection and processing thereof through a dedicated unit (not shown in the drawings).

The laser source 404 may be of continuous or pulsed type. In the case of a continuous laser source 404, the laser head 403 may be controlled to turn on and off according to deterministic or stochastic time trends.

The laser beam emitted by the laser source 404 is transported to the laser head 403 by an optical fibre 405. In accordance, the laser head 403 is connected to the laser source 404 through the optical fibre 405. As an alternative to the optical fibre 405, it is possible to provide a system of mirrors for transporting the laser beam.

The texturing group 40 preferably comprises at least one measuring device 406 configured to measure the distance between the laser head 403 and the surface 2 of the roll 1.

It should be noted that, in accordance with the machine 10 according to the present invention, it is possible to carry out a grinding, a texturing, or both the operations onto a roll 1 positioned only once between the two supporting elements 101. In other words, the machine 10 according to the present invention allows a grinding or a texturing to be carried out alternatively without needing to displace the roll from the position thereof, that is between the supporting elements 101.

In particular, the supporting elements 101 define a seat for a roll 1 to be treated, which is unique for both the treatments to be carried out on the surface 2 of the roll 1.

Preferably, the supporting structure 100 comprises a first guide 110 and a second guide 120. The first guide 110 and the second guide 120 are spaced from each other and parallel with respect to the longitudinal direction Y of development. The first guide 110 develops along the first direction Z.

The second guide 120 develops along the second direction z′.

The second guide 120 extends longitudinally between a first end 121 and a second end 122. More details about the first end 121 and the second end 122 of the second guide 120 are reported later in the present disclosure. Specifically, the grinding group 20 is slidably coupled with the first guide 110. The texturing group 40, on the other hand, is slidably coupled with the second guide 120. Accordingly, the grinding group 20 and the texturing group 40 are separated from each other.

The grinding group 20 is configured to translate along the first direction Z while the texturing group 40 is configured to translate along the second direction Z′. According to a preferred embodiment, the first guide 110 and the second guide 120 are parallel to each other and placed on opposite sides of the supporting structure 100 with respect to the rotation axis K.

Accordingly, the grinding group 20 and the texturing group 40 are also opposite to each other with respect to the roll 1 when it is positioned between the two supporting elements 101.

Preferably, the machine 10 comprises a control unit 60 configured to control the grinding group 20 and the texturing group 40.

In accordance, the control unit 60 is placed in signal communication with at least the grinding group 20 and the texturing group 40.

The control unit 60 is further placed in signal communication with the rotation motor 102.

In more detail, the grinding group 20 comprises a first carriage 201 slidably coupled with the first guide 110. The grinding group 20 further comprises a first slide 202 which is connected to the first carriage 201 and which is configured to slide with respect to the first carriage 201 along a first transverse direction T which is perpendicular to the first direction Z, that is, to the longitudinal direction Y of development.

The grinding tool 203 is connected, through a spindle (not illustrated in the drawings), to the grinding motor 204, placed in turn on the first slide 202. Thereby, the grinding tool 203 is transversally and longitudinally movable with respect to the surface 2 of the roll 1, and can reach each point of the surface 2 to be treated. In order to move the first carriage 201 and the slide 202, the grinding group 20 comprises first actuators (not illustrated in FIGS. 1 and 2 to 5, and only schematized in FIG. 1a where are denoted by reference number 211).

In particular, the first actuators are in signal communication with the control unit 60 and are configured to move the first carriage 201 and the first slide 202. The texturing group 40 comprises a second carriage 401 slidably coupled with the second guide 120.

The texturing group 40 comprises a second slide 402 connected to the second carriage 401 and configured to slide with respect to the second carriage 401 along a second transverse direction T′ which is perpendicular to the longitudinal direction Y of development. The laser head 403 is placed on the second slide 402. In accordance, the laser source 404 may be also connected to the second slide 402 or may be connected to the second carriage 401.

Alternatively, the laser source 404 may be placed in a fixed position with respect to the supporting structure 100, depending on the typology of laser beam in use and accordingly on the size and the weight of the laser source 404, and in respect of the limitations imposed by the length of the optical fibre 405 transporting the laser beam from the laser source 404 to the laser head 403.

In order to move the second carriage 401 and the second slide 402, the texturing group 40 comprises second actuators (not illustrated in FIGS. 1 and 2 to 5, and only schematized in FIG. 1a where are denoted by the reference number 411). The second actuators are in signal communication with the control unit 60 and are configured to move the second carriage 401 and the second slide 402.

The first and second actuators are for example of the linear electric motor type. Alternatively, the first and second actuators are for example controls with motors and recirculating ball screws, as long as they ensure high displacement precision and high readiness with respect to what is controlled by the control unit 60. The control unit 60 is further placed in signal communication with the grinding motor 204 and the laser head 403 and is configured to control the grinding motor 204, that is the grinding tool 203, and the laser head 403.

In particular, the texturing group 40 is configured to emit, through the laser head 403, a laser radiation directed towards the surface of the roll 1.

While the texturing group 40 is operating, the roll 1 is put in rotation at a preferably constant angular speed, and simultaneously the texturing group 40 is translated along the second direction Z′ at a preferably constant linear speed. The laser beam, interacting with the material of the roll 1 being treated, generates localized heating and/or a localized melting and/or a localized vaporization of the material depending on the parameters operating the treatment (for example, laser average power, peak power, focusing conditions of the beam, rotation speed of the roll, etc.). In this way, it is possible to modify the roughness features of the surface 2 of the roll 1, thus obtaining the texturing of the roll 1.

The texturing group 40 further comprises a nozzle 407 placed on the second slide 402 and configured to insufflate gas on the surface 2 of the roll 1. For example, the nozzle 407 is configured to insufflate an inert gas, such as nitrogen, helium, or argon.

Alternatively, the nozzle 407 is configured to insufflate a reactive gas, such as for example oxygen. Advantageously, it is possible to obtain also chemical variations on the surface 2 of the roll 1.

Preferably the machine 10 comprises a parking zone 503 configured to house at least partially the texturing group 40 when the grinding group 20 is working and/or when the texturing group 40 is not working. The parking zone 503 is a safety and protection zone for the texturing group 40, and in particular for the laser head 403.

In other words, the parking zone 503 is an area in which the texturing group 40 may be kept not contaminated by residues of grinding treatment, such as chips and/or metal particles of the roll 1 being treated, of abrasive and of binder of the grinding tool 203, and by potential drops of cutting fluids (i.e., fluids used, as known, during the grinding treatment which act as both refrigerant and lubricant), even in the sprayed form. The parking zone 503 allows to avoid that such residues contact the laser head 403, producing effects damaging to the operation of the laser head 403 itself and the optics present therein, incrementing the need for maintenance.

According to a preferred embodiment, the parking zone 503 is placed at one of the first end 121 and the second end 122 of the second guide 120.

Preferably, the parking zone 503 is placed in proximal position with respect to the supporting element 101 within which the rotation motor 102 is placed.

Still preferably, the parking zone 503 is placed at the second guide 120 at a set safety minimum distance D from the working zone 200, as shown in FIG. 3.

The minimum distance D is selected so as to keep the texturing group 40 sufficiently distant from the zone in which the grinding treatment is made, which, as disclosed, is characterized by producing treatment residues.

Preferably, the safety minimum distance D is greater than 0.2 m. More preferably, such safety minimum distance D is greater than 0.5 m. Even more preferably, the safety minimum distance D is greater than 1 m.

According to an embodiment, the end 121, 122 at which the parking zone 503 is placed is outside the casing 50. In other words, the second guide 120 extends partially outside the casing 50, as shown in FIGS. 1 and 4.

Advantageously, the parking zone 503 is kept outside the working zone 200. In this case, the casing 50 has at least an opening to allow the texturing group 40 to be moved over/from the parking zone 503.

Alternatively, the end 121, 122 at which the parking zone 503 is placed is inside the casing 50. In other words, the second guide 120 extends completely inside the casing 50. In this case, the parking zone 503 is inside the casing 50, as shown in FIGS. 2 and 3. According to a first embodiment, the parking zone 503 only consists in a zone of the second guide 120 the texturing group 40 is intended for, in order to stay at a safety minimum distance D from the working zone 200, and in particular from the zone within which the grinding tool 203 is movable.

According to a second embodiment, shown in FIG. 2, the parking zone 503 comprises a box-shaped body 502 placed onto the second guide 120 and apt to house the texturing group 40 therein. In accordance with such second embodiment, the box-shaped body 502 is configured to contain the texturing group 40 and to protect it from the contaminating residues produced by such treatment. Such embodiment is preferred in the case where the second guide 120 extends completely inside the casing 50. Such embodiment is however applicable even in case of a parking zone 503 outside the casing 50.

The box-shaped body 502 has an openable or open wall, to allow the texturing group 40 to slide inside the box-shaped body 502.

Preferably, the machine 10 comprises a gauge group 30 slidably coupled with the first guide 110 or the second guide 120. In particular, the gauge group 30 comprises a gauge 300 configured to detect dimensional parameters related to the surface 2 to be treated.

For example, the gauge 300 is configured to detect a geometrical profile of the roll 1, that is related to the surface 2.

The gauge 300 may be advantageously used also to detect parameters such as the roundness of the table 4 and the potential eccentricity thereof with respect to the rotation axis K.

In accordance, the gauge 300 is able to face the surface 2 of the roll 1.

The gauge 300 is further configured to measure the geometrical profile of the roll 1.

Still preferably, the gauge group 30 comprises a surface defects detection system 302. Such surface defects detection system 302 is adjacent to the gauge 300. The surface defects detection system 302 is preferably a system of non-destructive analysis, for example based on eddy currents, ultrasound or more. Advantageously, the surface defects detection system 302 allows to have indications about the shape, size, and position, comprising the depth inside the roll 1, of potential surface defects, both before and after the treatment of the roll 1.

Advantageously, the surface defects detection system 30 can be used also to detect defects proximate to the surface of the roll but placed below it.

Again, the gauge group 30, similarly to the grinding group 20 and the texturing group 40, preferably comprises a third carriage 301 configured to slide in the guide 110 or 120 the gauge group 30 is coupled to. The gauge group 30 is thus movable along the first direction Z if coupled with the first guide 110 or along the second direction Z′ if coupled with the second guide 120.

The gauge group 30 is also placed in signal communication with the control unit 60.

Preferably, the machine 10 comprises a cleaning unit 70 associated with the supporting structure 100 and configured to remove processing waste and cooling liquid residues from the surface 2 of the roll 1 being treated. In particular, the processing waste, as mentioned above, comprises for example chips or metal powder, formed during the treatment of the roll 1, but also cutting fluids and/or lubricant fluids, accumulated following the grinding treatment.

The cleaning unit 70 is further configured to dry the roll 1 being treated.

For example, the cleaning unit 70 comprises one or more brushes and/or cleaning blades and/or nozzles for emitting compressed air and/or other known elements, configured to be brought into contact or in proximity to the roll 1 while it is put in rotation.

The cleaning unit 70 comprises a fourth carriage 701 slidably coupled with the first guide 110 or the second guide 120.

The cleaning unit 70 is in signal communication with the control unit 60.

In a fifth embodiment, such as for example that illustrated in FIG. 5, the supporting structure 100 comprises a single guide 150. Thus, in accordance with such embodiment, the first carriage 201 and the fourth carriage 701 slide on the single guide 150, on which the second carriage 401 and the third carriage 301 also slide. In the particular embodiment of FIG. 5, such single guide 150 is placed on a side of the machine 10 and develops along a third direction Z″. In such embodiment, in order to move the carriages 201, 301, 401, 701, for a section of the single guide 150 it is necessary that such section is free and accessible, therefore it is necessary to displace the carriages 201, 301, 401, 701 present in such section. Thus, moving the single carriages 201, 301, 401, 701 is slow and cumbersome and involves an increase in treating time. Furthermore, in accordance with such embodiment, the first end 121 and the second end 122 necessarily need to comprise suitable spaces (not illustrated in the drawings) for positioning the carriages 201, 301, 401, 701 during the steps in which they are not operating. The above-described embodiments including two guides from each other are preferred over the separated embodiment with the single guide 150 as they allow the carriages 201, 301, 401, 701 to be smoothly moved, reducing the number of required displacements thereof and thus also the treating time. Furthermore, for the same maximum length of the treatable table 4, the overall dimension of the machine 10 along the longitudinal direction Y of development is smaller in the case of a machine 10 with separated first 110 and second guides 120, as there is no need to provide extra spaces for positioning the carriages 201, 301, 401, 701, allowing more compact size.

Preferably, the machine 10 comprises air suction and filtering means 501 configured to suck and filter the air inside the casing 50, and in particular in the working zone 200.

The air suction and filtering means 501 are also in signal communication with the control unit 60.

Such air suction and filtering means 501 are placed at the casing 50, preferably in the opposite position with respect to the parking zone 503. Advantageously, the sucked stream is kept separated from the parking zone 503, without hitting it, and thereby the laser head 403 is further preserved from the impact and/or from accumulating with/of potential circulating waste. According to a preferred embodiment, the laser head 403 is configured to emit an air stream when the grinding group 20 is working and/or when the texturing group 40 is in the parking zone 503. In accordance, the laser head 403, shown in FIG. 6, has a side channel 410 for air supply. In particular, the laser head 403 has an outlet port 409 of the laser beam and such channel 410 is in fluid communication with such port 409. Thus, the air stream exits the same port 409 the laser beam exits when the grinding group 20 is working. Advantageously, the air stream moves away from the port 409 potential residues or processing waste reaching the laser head 403, thus further limiting the risk of impurity deposit. In accordance with a further embodiment, shown in FIG. 4, the supporting structure 100 comprises a first portion 130 and a second portion 140 which are separated from each other and rigidly jointed. In particular, the first guide 110 is associated with the first portion 130 and the second guide 120 is associated with the second portion 140.

In more detail, the first portion 130 and the second portion 140 are rigidly connected to a same foundation (not illustrated) which allows to keep them in position with respect to each other minimizing relative displacements. It should be noted that such embodiment is preferable in the case of large size machines 10. Regarding the supporting elements 101, it should be noted that for the grinding treatments, normally the roll is supported on the necks 6 or, although more rarely, on the shoulders 7. In this case, the supporting elements 101 comprise two steady rests 101b, as shown in FIGS. 7, 7a and 7b. In particular, each steady rest 101b has two plain bearings 101c.

Such steady rests 101b, in addition to withstanding the own weight of the roll 1, allow to effectively counter the radial thrusts generated by the grinding tool 203 during the treatment, limiting the bending of the roll 1 and avoiding the introduction of vibration or instability phenomena, which would remarkably deteriorate the treatment quality.

Optionally, the supporting elements 101 further comprise two matching elements, called bumpers 103. Such bumpers 103 are shown in FIG. 7 and are opposed to each other and aligned along the rotation axis K. The bumpers 103 are configured to act as matching on the end surfaces of the centres 5 of the roll 1, preventing potential displacements thereof along the rotation axis K. This configuration, that is the support on necks 6 and the axial constraint only with the bumpers 103, is suitable for managing the rotation speeds of the roll 1 normally used for the grinding treatment, which may be in the order of 50-100 rpm.

Furthermore, the bumpers 103 are used to unjoint the roll 1 from a headstock and tailstock system 101a, more details thereof are provided below, in a radial direction. Advantageously, this allows to avoid a hyperstatic constraint condition of the roll 1, which would cause an abnormal wear of the headstock and tailstock system 101a and/or the steady rests 101b. Instead, higher rotation speeds, e.g., more than 300 rpm, are normally required for the texturing treatments through laser head 403. This requirement is related to the size of the laser head 403, whose print on the roll 1 has size in the order of μm. Thus, in order to minimize the duration of treatment, it is useful to set the rotation speed of the roll at significantly higher values than the grinding operation. From this point of view, the support on the necks 6 is not suitable for managing the rotation speeds required for texturing. For this reason, in such step the roll is supported on the centres 5. In particular, the supporting elements 101 comprise the above-mentioned headstock and tailstock system 101a, as visible in FIGS. 7, 7a and 7b, configured to support the roll 1 at the centres 5. Indeed, such type of support is more suitable for high rotation speeds than the support by the steady rests 101b.

Thus, in a preferred configuration, the machine 10 comprises both the steady rests 101b and the headstock and tailstock system 101a.

In particular, it is possible to provide that during the step of grinding, the roll 1 is supported on the necks 6 by the steady rests 101b, and that, simultaneously, the headstock and tailstock system 101a is simply engaged in the centres 5, in order to only joint the roll 1, as shown in FIG. 7a. In order to avoid hyperstaticity, it is necessary to provide a certain backlash between the elements 101a and the centres 5 of the roll 1. Subsequently, at the end of the grinding treatment, before moving on to the texturing treatment, the headstock and tailstock system 101a is further pressed on the centres 5, so as to withstand the weight of the roll 1. The above-mentioned plain bearings for holding the necks 6 are then discharged, moving them away, even slightly, from the surface of the necks 6 themselves, as shown in FIG. 7b. At this point, it is possible to proceed with the texturing treatment by setting the new rotation speed of the roll 1.

During the step of grinding, the roll 1 is supported by the steady rests 101b and is put in rotation by a spindle by means of a faceplate and driving collar (with driving dog) system, known in itself to a person skilled in the art.

During the step of texturing, the roll 1 is supported by the headstock and tailstock system 101a through which, furthermore, the motion is transmitted from the spindle to the roll 1.

It should be noted that such procedure avoids using the bumpers 103 and allows to quickly switch from a type of constraint to another. Indeed, the bumpers 103, if present, are connected to the headstock and tailstock system 101a. Thus, at the end of the grinding treatment, it would be necessary to move away the headstock and tailstock system 101a releasing the bumpers 103, manually remove the bumpers 103, move away, even by a few millimetres, the holding plain bearings 101c leaving the roll 1 in position to be caught in the headstock and tailstock system 101a and finally block it therein, with the need for manual intervention and consequent lengthening of the total treating time.

A method for carrying out surface treatments onto a roll 1 by a machine 10 described above forms also part of the present invention.

The method comprises a first step of positioning between the supporting elements 101 a roll 1 which has a surface 2 to be treated.

The method comprises a further step, following the first, of detecting dimensional parameters related to the surface 2 to be treated. Such step is carried out by means of the gauge group 30 and in particular of the above-described gauge 300, and comprises a sub-step of detecting a geometrical profile of the roll 1. In particular, such step is useful to determine the quantitative and qualitative features of the surface treatments to be carried out onto the roll 1.

Subsequently, there is a further step of driving the rotation motor 102 to put in rotation the roll 1.

The method provides a step of controlling the grinding group 20 for grinding the surface 2 to be treated depending on the detected dimensional parameters and on those to be obtained at the end of the treatment. In particular, such step is conducted by the above-described control unit 60, which controls the movement of the grinding tool 203 by adjusting the movement of the first carriage 201 and the slide 202.

The method also provides a step, following that of controlling the grinding group 20, of moving the texturing group 110 from the parking zone 503 to the working zone 200. Such step is in particular carried out at the end of the grinding treatment.

Thus, the method comprises a step of controlling the texturing group 40 for texturing the surface 2 to be treated depending the on detected dimensional parameters. Such step comprises a sub-step of controlling the laser head 403 to emit a laser beam on the surface 2 of the roll 1. The step of controlling the texturing group 40 comprises a further sub-step of moving the laser head 403 for texturing the entire surface 2 of the roll 1 or part thereof. Such sub-steps are also conducted by the control unit 60, which controls the movement of the second carriage 401 and the slide 402. Following the step of controlling the texturing group 40 for texturing the surface 2, that is at the end of the texturing treatment, the method comprises a step of stopping the rotation of the roll 1. Such step is followed by further steps of positioning the texturing group 40 in the parking zone 503 and removing the roll 1 from the machine 10.

Optionally, between the grinding treatment and the texturing treatment, a step of removing potential processing waste from the ground roll 1 may be provided. Such step is conducted in particular between the step of controlling the grinding group 20 and the step of moving the texturing group 110 from the parking zone 503 to the working zone 200.

The step of removing waste is carried out through the above-described cleaning group 70.

With such machinery 1, it is also possible to conduct, on the roll 1, only one of the two surface treatments, for example only one grinding treatment or only one texturing treatment.

In accordance, the step of removing potential processing waste from the roll 1 is carried out before the step of removing the roll 1 from the machine 10.

Advantageously, the machine 10 and the method described above ensure operating flexibility so as to maximize the performance of the machine 10 in any condition.

From the performed description, the features of the machine and the method object of the present invention are clear, as well as the advantages thereof are clear. It is clear, finally, that the machine and the method thus conceived are capable of several modifications and variations, all falling into the invention; furthermore, all the details are replaceable by technically equivalent elements. Practically, the used materials, as well as the size, may be any, depending on the technical requirements.

1. A machine for carrying out surface treatments onto rolls, comprising:
a supporting structure extending along a longitudinal direction of development;
a casing placed at least partially to cover said supporting structure;
at least two supporting elements placed on that supporting structure, opposed to each other and aligned along a rotation axis parallel to said longitudinal direction of development, said supporting elements being configured to support a roll having a surface to be treated;
a rotation motor configured to put in rotation said roll when supported by the two supporting elements;
a grinding group slidably connected to the supporting structure and comprising a grinding tool, said grinding tool being able to face said roll and movable over a working zone for grinding at least part of the surface of said roll;
a texturing group slidably connected to the supporting structure and comprising a laser head, said laser head being able to face said roll and movable over said working zone for texturing at least part of the surface of said roll; and
a control unit placed in signal communication with said grinding group and with said texturing group, said control unit being configured to control said grinding group and said texturing group.

2. The machine according to claim 1, wherein the supporting structure comprises a first guide and a second guide spaced from each other and parallel with respect to said longitudinal direction of development, said grinding group being slidably coupled with said first guide and said texturing group being slidably coupled with said second guide.

3. The machine according to claim 2, wherein said first guide and said second guide are parallel to each other and placed on opposite sides of the supporting structure with respect to said rotation axis.

4. The machine according to claim 2, further comprising a parking zone configured to house at least partially the texturing group when said grinding group is working and/or when said texturing group is not working.

5. The machine according to claim 4, wherein said second guide extends longitudinally between a first end and a second end, said parking zone being placed at one end of said first end and second end of said second guide.

6. The machine according to the preceding claim 5, wherein said end at which the parking zone is placed is outside said casing.

7. The machine according to claim 5, wherein said end at which the parking zone is placed is inside said casing.

8. The machine according to claim 6, wherein said parking zone comprises a box-shaped body placed onto said second guide and apt to house said texturing group therein.

9. The machine according to claim 7, wherein said parking zone is placed at said second guide at a set safety minimum distance from the working zone.

10. The machine according to claim 9, wherein said safety minimum distance is greater than 0.2 m.

11. The machine according to claim 2, further comprising a gauge group slidably coupled with said first guide or said second guide, said gauge group comprising a gauge configured to detect dimensional parameters related to said surface to be treated.

12. The machine according to claim 11, wherein said gauge group comprises a surface defects detection system.

13. The machine according to claim 1, further comprising a cleaning unit associated with said supporting structure and configured to remove processing waste from the surface of said roll being treated.

14. The machine according to claim 1, further comprising air suction and filtering means configured to suck and filter air in said working zone.

15. The machine according to claim 4, wherein said laser head is configured to emit an air stream when the texturing group is in the parking zone.

16. The machine according to claim 2, wherein said supporting structure comprises a first portion and a second portion separated from each other and rigidly jointed, said first guide being associated with said first portion and said second guide being associated with said second portion.

17. The machine according to claim 1, wherein:
said grinding group comprises a first carriage slidable along a first direction parallel to said longitudinal direction of development and a first slide which is connected to said first carriage in a slidable manner with respect to it along a first transverse direction perpendicular to said first direction, first actuating means being provided to move said first carriage and said first slide; and
said texturing group comprises a second carriage slidable along a second direction parallel to said longitudinal direction of development and a second slide which is connected to said second carriage in a slidable manner with respect to it along a second transverse direction perpendicular to said second direction, second actuating means being provided to move said second carriage and said second slide.

18. The machine according to claim 1, wherein said at least two supporting elements comprise:
a headstock and tailstock system disposed to support said roll, and
two steady rests disposed to support said roll, wherein said headstock and tailstock system and said two steady rests are alternatively couplable with said roll.

19. The machine according to claim 18, wherein each of said steady rests comprises a pair of plain bearings.

20. Method A method for carrying out surface treatments onto a roll by a machine according to claim 1, wherein said machine further comprises:
a gauge group slidable along a direction parallel to said longitudinal direction of development, said gauge group comprising a gauge configured to detect dimensional parameters related to said surface to be treated, and
a parking zone configured to house at least partially said texturing group when said grinding group is working and/or when said texturing group is not working, said method comprising the steps of:
positioning a roll having a surface to be treated between said supporting elements;
detecting dimensional parameters related to said surface to be treated;
driving said motor to put in rotation said roll;
controlling said grinding group for grinding said surface to be treated depending on said detected dimensional parameters;
moving said texturing group from said parking zone to said working zone; and
controlling said texturing group for texturing said surface to be treated depending on said detected dimensional parameters, wherein during said step of controlling said grinding group for grinding said surface, said texturing group is housed in said parking zone.

21. The method according to claim 20, wherein
said at least two supporting elements of said machine comprise:
a headstock and tailstock system disposed to support said roll, and
two steady rests disposed to support said roll, wherein said headstock and tailstock system and said two steady rests are alternatively couplable with said roll, wherein:
during said step of controlling said grinding group for grinding said surface to be treated, a weight of said roll is supported by said steady rests, and
during said step of controlling said texturing group for texturing said surface to be treated, the weight of said roll is supported by said headstock and tailstock system.
